(19) United States
(12) Patent Application Publication
(10) Pub. No.: US 2015/0172522 A1
(43) Pub. Date: Jun. 18, 2015

(54) DEVICES AND METHODS FOR CLOSE-UP IMAGING WITH A MOBILE ELECTRONIC DEVICE

(71) Applicant: olloclip, LLC, Huntington Beach, CA (US)

(72) Inventors: Patrick D. O'Neill, Huntington Beach, CA (US); Chong Pak, Lakewood, CA (US); Jason Patrick, Long Beach, CA (US)

(21) Appl. No.: 14/570,835

(22) Filed: Dec. 15, 2014

Related U.S. Application Data
(60) Provisional application No. 61/916,723, filed on Dec. 16, 2013.

(51) Int. Cl. H04N 5/225

(52) U.S. Cl. CPC H04N 5/2254; H04N 5/2257

(57) ABSTRACT

Devices and methods may be used for close-up imaging, such as positioning devices and methods configured to position an object to be photographed at a particular distance from an onboard camera of a mobile electronic device, and/or light-modifying devices and methods configured to generate, direct or redirect, attenuate, filter, diffuse, diminish and/or otherwise modify light that will be impinging on the object to be photographed and/or that will reflect from the object to be photographed onto the onboard camera of the mobile electronic device.

### RELATED APPLICATION

This application claims the benefit of U.S. Provisional Patent Application No. 61/916,723, filed on Dec. 16, 2013 and entitled “DEVICES AND METHODS FOR CLOSE-UP IMAGING WITH A MOBILE ELECTRONIC DEVICE,” the entire content of which is hereby incorporated by reference and made part of this specification for all that it discloses.

### BACKGROUND

1. Field

The field of the invention relates generally to imaging accessories and specifically to imaging accessories for mobile devices.

2. Description of the Related Art

In recent years, many advances in computer networking and processing technology have made it possible for mobile devices to include cameras that permit users to capture images. In many cases, these images can be stored, processed, and transmitted. However, there are many design constraints on onboard cameras in mobile devices that can limit the weight, size, expense, shape, adjustability, and overall quality of the lensing systems of such cameras. Consequently, many cameras in mobile devices are inadequate for certain imaging needs.

Lensing systems may be mounted or attached to mobile devices such that one or more auxiliary lenses are positioned substantially over the onboard camera lenses of the mobile devices. The auxiliary lenses can enhance or alter the light that may be captured by the onboard cameras to generate an image.

### SUMMARY OF SOME EMBODIMENTS

Close-up imaging is frequently used in photography, filmmaking, and medical imaging, among other fields. Many different types of devices and methods may be used for close-up imaging, such as positioning devices and methods configured to position an object to be photographed at a particular distance from an onboard camera of a mobile electronic device, and/or light-modifying devices and methods configured to generate, direct or redirect, attenuate, filter, diffuse, diminish and/or otherwise modify light that will be impinging on the object to be photographed and/or that will reflect from the object to be photographed onto the onboard camera of the mobile electronic device. In some embodiments, the particular distance from the onboard camera and the object to be photographed can be adjusted and/or changed before a photograph is taken, but remains constant during the photographing process.

An example of a close-up imagining device is a lens hood. In some embodiments, a lens hood can be generally translucent or generally opaque. In some embodiments, a lens hood can be both a positioning device and a light-modifying device. Many other devices and methods can be used instead of or in addition to a lens hood for positioning and/or light-modifying for close-up imaging. Some close-up imagining devices are positioning devices, but not light-modifying devices; and some close-up imaging devices are light-modifying devices but not positioning devices. In some embodiments, a close-up imaging device may be mounted or attached to an onboard camera of a mobile electronic device such that the close-up imagining device is positioned substantially over a camera lens of an imaging device. In some embodiments, a close-up imaging device can comprise a light source. A light source may be used in close-up imaging to provide lighting onto the subject. A light source may be used with or without other close-up imaging devices.

Other types of imaging accessories include a camera stand. In some embodiments, a camera stand is intended to provide stability for the mobile device, and to fix and/or to adjustably fix a close-range distance of the lens from the subject while operating the mobile device for imaging. A camera stand can be placed on the body of the imaging device or mobile device, or some portion thereof, to prevent shaking, dropping, and the like.

### BRIEF DESCRIPTION OF THE DRAWINGS

Examples of various features of some embodiments will now be described with reference to the following drawings. Throughout the drawings, reference numbers may be re-used to indicate correspondence between referenced elements. The drawings are provided to illustrate example embodiments described herein and are not intended to limit the scope of the disclosure.

FIG. 1A illustrates an example of a mobile electronic device.

FIG. 1B illustrates a perspective view of an embodiment of a lens system with a lens hood attached to a mobile electronic device.

FIG. 1C illustrates a side view of the lens system and mobile electronic device of FIG. 1B.

FIG. 2A illustrates a perspective view of an embodiment of a mobile electronic device and a lens system with a structure configured to convey light from a flash of the mobile device.

FIG. 2B illustrates a side view of the mobile electronic device and lens system of FIG. 2A.

FIG. 2C illustrates a perspective view of the mobile electronic device and lens system of FIG. 2A with an attached lens hood.

FIG. 3A illustrates a perspective view of an embodiment of a mobile electronic device and a lens system with a structure configured to convey light from a flash of the mobile device.

FIG. 3B illustrates a side view of the mobile electronic device and lens system of FIG. 3A.

FIG. 3C illustrates a perspective view of the mobile electronic device and lens system of FIG. 3A with an attached lens hood.

FIG. 4A illustrates a perspective view of an embodiment of a mobile electronic device and a lens system with a lens hood having a battery powered light source.

FIG. 4B illustrates a side view of the mobile electronic device and lens system of FIG. 4A.

FIGS. 5A-5B and 6A-6B illustrate side and plan views, respectively, of embodiments of a mobile electronic device and lens system with a lens hood and a periscopic light chamber that conveys light from a mobile device display to the lens hood.

FIG. 7A illustrates a perspective view of an embodiment of a lens system with a lens hood.

FIG. 7B illustrates a side view of an embodiment of a lens system with a lens hood with a telescopically adjustable focus distance.

FIG. 8A illustrates a side view of an embodiment of a mobile electronic device and a lens system with a lens stand.

FIG. 8B illustrates an exploded perspective view of the lens system of FIG. 8A.

FIG. 8C illustrates a perspective view of the mobile electronic device and lens system of FIG. 8A without a lens hood.

FIG. 9A illustrates a top-side perspective view of an embodiment of a mobile electronic device and a lens system with a mobile device stand with a light source.

FIG. 9B illustrates a bottom-side perspective view of the lens system of FIG. 9A.

### DETAILED DESCRIPTION OF EMBODIMENTS

The present disclosure relates generally to imaging devices and methods for close-up imagining using mobile electronic devices. Many different structures, features, steps, and processes are shown and/or described in discrete embodiments for convenience, but any structure, feature, step, or process disclosed herein in one embodiment can be used separately or combined with or used instead of any other structure, feature, step, or process disclosed in any other embodiment. Also, no structure, feature, step, or processes disclosed herein is essential or indispensable; any may be omitted in some embodiments.

The term “mobile electronic devices” is used in its ordinary sense, and includes mobile telephones, mobile texting devices, media players, electronic pad devices, laptop computers, desktop computers, gaming devices, wearable electronic devices (e.g., “smart watches” or “smart eyewear”), and/or mobile electronic communication devices capable of linking electronically to another device or to a network such as the Internet, etc. Some mobile electronic devices include one or more onboard cameras that can be used for various imaging purposes, such as photography and video recording. For example, imaging accessories can be used with a mobile device to stabilize the mobile device, adjust focus, provide light, change angle, and the like. Imaging devices can include a retainer for connecting an imaging device to a mobile electronic device, a lens, a light-modifying device and/or a positioning device (e.g., a lens hood, a camera stand, etc.), a light source, a lens cover, a lens filter, etc.

In some situations, it can be difficult to take close-up images with an onboard camera of a mobile electronic device due to certain design constraints of the mobile electronic device. For example, the design of many mobile devices may limit the weight, size, expense, shape, adjustability, and overall quality of the lensing systems (e.g., the onboard camera) included in the mobile device. As a result, using an onboard camera alone (e.g., without imaging accessories) may not produce magnified or close-up images of desired size, quality, resolution, or lighting. The deficiencies of onboard camera lenses can be addressed by modular or detachable optical systems. Some examples of modular or detachable optical systems for mobile electronic devices (including the olloclip® lens) that can be used with the embodiments disclosed herein are illustrated and described in U.S. Pat. No. 8,279,544, which is titled “Selectively Attachable and Removable Lenses for Mobile devices” and which issued on Oct. 2, 2012, the contents of which are incorporated by reference herein in its entirety.

The term “lens” in this specification is used in its ordinary sense, and includes powered lenses (e.g., lenses that focus, magnify, enlarge, or otherwise alter the direction of light passing through the lens), plano lenses (e.g., lenses that are generally planar, lenses that do not taper in thickness, and/or lenses that are not powered), protective lenses, simple lenses, compound lenses, generally spherical lenses, generally toroidal lenses, generally cylindrical lenses, etc. Any imaging device described or illustrated in this specification can include a retainer attached to one or more lenses or optical regions with one or more different features, including but not limited to a constant or variable magnifying lens, a wide-angle lens, a fish-eye lens, a telescopic lens, a macro lens, a constant or variable polarizing lens, an anti-reflection lens, a contrast-enhancing lens, a light-attenuating lens, a colored lens, or any combination of the foregoing, etc. An imaging device can comprise a retainer with a plurality of attachment regions for removably or permanently attaching multiple lenses to the same retainer. For example, in some embodiments, a first lens is attached to a first side of the retainer and a second lens is attached to a second side of the retainer.

In some embodiments, the imaging device comprises one or more macro lenses or one or more combinations of macro lenses to provide a variety of different magnifications. For example, a first macro lens of a first magnification (e.g., at least about 5×) can be used by itself or in combination with a second macro lens that is removably attached in optical functionality with the first macro lens to yield a second, higher magnification (e.g., at least about 10×), and a third macro lens can provide a third magnification that is higher than the second magnification (e.g., at least about 15×). Each of the macro lenses can have a relatively short focal length (in use when combined with the lens of the onboard camera), such as less than or equal to about 2 inches, but greater than or equal to about ½ inch. In some embodiments, as illustrated, the focal length of one or more of the macro lenses is less than or equal to about the length of an edge of a mobile electronic device to which the imaging device is configured to attach.

Some aspects of the present disclosure relate to imaging devices or accessories that can be used with a modular lensing system and a mobile device. As illustrated, an imaging device or accessory can include a lens hood that connects to the modular lensing system. The lens hood used in connection with a modular lensing system can be used to modify the light that impinges upon a subject to be photographed and/or to prevent at least a portion of peripheral or non-image forming ambient light from entering the onboard lens, and/or to diffuse and/or to mix such light, thereby providing a user with greater control over the lighting in the image. A positioning device (e.g., a lens hood, a camera stand, an offset or measuring pole or block, etc.) can be used to place an onboard camera over the subject and to position an onboard lens and/or an auxiliary lens at a desired distance from the subject to be photographed (such as at a distance generally corresponding to the focal length of the onboard lens and/or auxiliary lens, such as a macro lens). The desired distance can be a precise, adjustable, and/or constant distance. In some embodiments, at least a portion of the imaging device can be translucent, transparent, or semi-transparent to allow some diminished and/or selectively attenuated ambient light to illuminate the subject to be photographed. In some embodiments, an imaging device can diffuse the light generally evenly over the object or field of view. In some embodiments, the imaging device can comprise an opaque, light-blocking hood that resists or prevents entry of ambient light and that instead provides controlled lighting within the hood for forming an image from an onboard flash or onboard screen or some other artificial lighting source.

For example, in some embodiments, the imaging accessory can include a light source. The light source may be used to provide lighting in addition to ambient lighting, or to provide lighting of desired color, intensity, or frequency. Such light sources may or may not be used with a lens hood. For example, the light source can be a light pipe connected to a modular lens component substantially covering or otherwise in light communication with the flash on a mobile device. In some embodiments, the light pipe can convey light from the flash of the mobile device to an area generally in the field of view of the onboard camera lens of the mobile device in order to illuminate the subject sufficiently (e.g., such as when there is not sufficient ambient lighting or not sufficient ambient lighting of a desire quality). In some embodiments, the light source can be connected to other imaging accessories, such as a lens hood or a camera stand. In some embodiments, the light source can include a battery-powered illumination source, such as a bulb or LED, that provides light independently from any onboard flash of the mobile device. The battery power can be supplied by the imaging accessory or by the mobile electronic device.

In some embodiments, the light source can include a periscopic light chamber and a mobile device application. For example, the periscopic chamber can include a light-capturing portion on a first side, a light-projecting portion on a second side that is different from the first side, and a connecting portion that conveys light between the two portions. The light-capturing portion can cover a portion of a display screen of a mobile device to capture light. One or more qualities of the light (e.g. color, intensity, etc.) generated by the display screen may be generated, controlled, or set using a mobile device application. Light generated by the display screen and captured by the light capturing portion can then be conveyed through the connecting portion to the light-projecting portion. The light-projecting portion may project or otherwise convey the light into the field of view of a mobile device's camera lens or an auxiliary lensing system. In some embodiments, the light may be used in conjunction with a positioning or light-modifying device, such as a lens hood.

Imaging devices may be used to help provide a fixed or constant distance between subject and a lens used with the mobile electronic device, including a fixed or constant distance that can be adjusted or changed between usages. In some embodiments, a positioning device (such as a lens hood, a camera stand, or some other positioning device) can be sized and dimensioned so that a first end of the positioning device is configured to be attached to a retainer for a mobile electronic device or to a mobile device itself, and a second end is configured to contact or be positioned near or adjacent to a subject or object to be photographed. In some embodiments, the positioning device generally or entirely encloses or generally or entirely surrounds a perimeter of a region to be photographed; however, in some embodiments, the positioning device does not enclose or surround the region to be photographed.

One or more positioning devices, such as lens hoods, can be attached to the retainer or imaging device. In some embodiments, at least one positioning device is attached to a first side of the retainer or imaging device, and at least one positioning device is attached to a second side of the retainer or imaging device, which is generally opposite from the first side. The attachment between a retainer or imaging device and the positioning device can be removable and reattachable. In some embodiments, the positioning device can be made up of at least two portions that are movable with respect to each other. For example, a first portion of a lens hood may be moved relative to a second portion of the hood in order to increase or decrease the distance between the mobile device and the subject. For example, a user may actuate (e.g., by sliding, pulling, rotating, pushing, etc.) a first portion of the hood relative to a second portion of the hood in order to adjust the length of the hood and therefore change a length of the positioning device and also the distance between the mobile device and the subject. The distance can be selected or chosen to correspond to one of a plurality of desired focal distances for one of a plurality of lenses, such as a macro lens, an onboard camera lens, or another lens.

In some embodiments, an imaging device can comprise one or more stabilizing devices such as a lens stand. For example, a user may use a lens stand to minimize shaking of mobile device while taking close-up image, or to position the mobile device vertically above the subject and allow the mobile device to operate without touching the mobile device. In some embodiments, the lens stand may include a light source. The lens stand may be used with the mobile device alone, or with imaging accessories described herein, such as lens hood, a periscopic light chamber, and the like.

Although aspects of the embodiments described in the disclosure will focus, for the purpose of illustration, on use of an auxiliary lensing system and other photography components with the mobile devices on which the imaging accessories are installed, the structures and techniques disclosed herein may be applied to any accessory or auxiliary structure. Various aspects of some embodiments will now be described with regard to certain examples and which are intended to illustrate but not limit the disclosure.

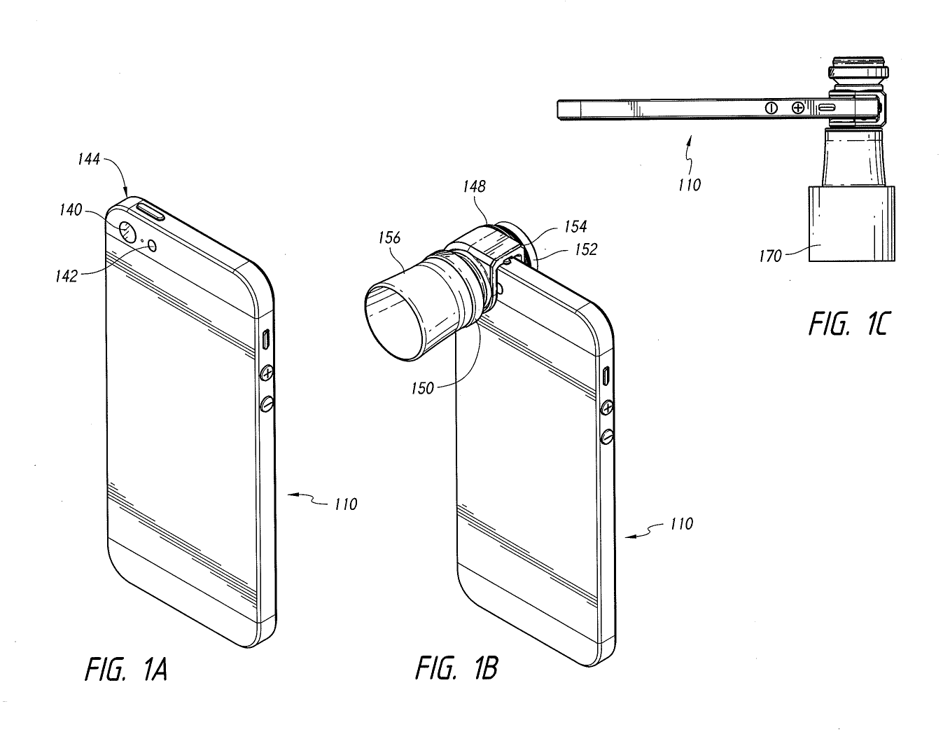

Referring now to FIGS. 1A-1C, an embodiment of a lens hood for a mobile device is illustrated. One advantage, among others, of some embodiments of the lens hood 156 is that it can be used to set a focal distance between the mobile device 110 and the subject 170 by placing the lens hood 156 at a static or user-selectable distance over the subject 170. In other words, the lens hood 156 or other positioning device can help the user to position the mobile device 110 at a particular distance from the object to be photographed that generally matches the focal distance or length of the lensing system. As illustrated in FIGS. 1B-C, the lens hood 156 can be connected to a modular lensing system 148. The modular lensing system 148 can include one or more of the features of any of the lenses or retainers described or illustrated in this specification and/or in U.S. Pat. No. 8,279,544, and all descriptions and illustrations of such components are hereby incorporated by reference in this specification. The modular lensing system can include a retainer portion 154 and one or more lenses or optical regions, such as a first lens 150 and a second lens 152. The modular lensing system 148 can cover a corner 144 of a mobile device 110. Various optical elements, such as lenses, lens filters, and the like may be mounted to modular lensing system 148 via the retainer portion 154. The corner 144 of the mobile device 110 can include an onboard camera 140 and a flash 142.

In some embodiments, any component or device disclosed or illustrated in this specification can include or be configured to attach to a retainer that comprises a rear wall configured to contact or be positioned over a portion of a rear surface of a mobile electronic device, a front wall configured to contact or be positioned over a portion of a front surface of a mobile electronic device, and/or a wall or other connecting structure extending between the front wall and second wall. In some embodiments, the retainer can be configured to attach to and be in contact with only a corner portion of a mobile electronic device where an onboard camera is located on the mobile electronic device. In some embodiments, the front and/or rear walls can be sized and dimensioned to extend over only a corner of a mobile electronic device and/or to remain attached to the mobile electronic device only by friction between the retainer and the region of contact on the mobile electronic device, without extending across an entire edge of the mobile electronic device, without contacting an opposing side of a mobile electronic device, without requiring dynamic mounts, and/or without requiring other mounting structures to be affixed to the mobile electronic device. In some embodiments, the retainer is made of a relatively soft plastic material. Any type of retainer can be used to help position an auxiliary or supplemental lens or lens system in optical communication with an onboard camera of a mobile electronic device. Other examples include: retainers that are configured to attach across the top and/or side of a mobile electronic device; retainers that configured to attach using magnets or adhesive or some other temporary surface attachment device; retainers that are formed into or attachable to a case for a mobile electronic device; retainers that attach onto a ring or other attachment structure adjacent to the onboard lens of the mobile electronic device; and/or retainers that are configured to attach using a screw-on or rotatable or bayonet-type attachment.

As illustrated in FIGS. 1B-C, the lens hood 156 can be configured to attach to a modular lensing system 148 having a first lens 150 and a second lens 152. The retainer portion 154 of the modular lensing system 148 can be shaped and sized to fit over the corner area 144 of the mobile device 110. The lens hood 156 can attach to the first lens 150 or the second lens 152, or to the retainer portion 154 of the modular lensing system 148, such that the lens hood 156 is positioned generally in front of the desired lens 150, 152 and the onboard camera lens 140.

In some embodiments, the lens hood 156 can be generally frusto-conical, generally cylindrical, or generally conical in shape. For example, the hood 156 illustrated in FIG. 1C is generally frusto-conical. As illustrated, the front edge of the lens hood 156 can be generally circular and generally co-planar to help seal off the subject to be photographed from ambient illumination that does not pass through the wall of the lens hood when the lens hood 156 is placed flush against the subject to be photographed. By placing the lens hood 156 near, adjacent to, or over the subject 170, the longitudinal length of the lens hood 156 can set the distance between the subject 170 and the mobile device, which can generally correspond to the focal lens of a lens, without additional manual focusing or trial-and-error hovering of the mobile electronic device over the subject 170. As illustrated, in some embodiments, the length of the positioning device or lens hood 156 can be: (a) less than or equal to about the length of a side of a mobile electronic device to which the imaging device is configure to attach; (b) at least as large as the greatest width of the retainer; (c) at least as large as the thickness of the retainer and lenses, from the front side to the back side; (d) less than or equal to about 2 inches and/or greater than or equal to about ½ inch; and/or (e) about the same size as or smaller than the diameter or cross-sectional width of an opening on the positioning device at the end of the positioning device that is configured to contact the subject to be photographed. In some embodiments, the length of the positioning device or lens hood can be different from those described in the foregoing list. In some embodiments, a translucent lens hood 156 can be configured to provide a diffuse, generally uniform, and/or generally evenly mixed light source to reflect off of the object to be photographed and to enter the onboard camera to form a photographic image. A user may place the lens hood 156 to generally cover, generally surround, or generally enclose a subject 170 that is smaller than the lens hood 156 inside the lens hood 156 for a desired imaging effect, or to immobilize the subject 170. In some embodiments, the lens hood 156 can be used to resist, diminish, or prevent peripheral or non-image forming light from entering the lens, thereby reducing or preventing lens flare from forming on the image.

All or part of the positioning device, such as lens hood 156, can be made of translucent or semi-transparent material to allow some ambient light to illuminate the subject 170 to be photographed. For example, a translucent lens hood 156 can diffuse light evenly over the subject 170. The lens hood 156 may alternatively be made of opaque material. In this embodiment, the lens hood 156 can be placed onto a subject with its own light source, a subject placed over a light source, a glowing subject, and etc. In some embodiments, the lens hood 156 can have different shapes, such as a generally cubic or generally pyramidal shape. In some embodiments, the lens hood 156 surface can be fenestrated with a plurality of openings, or it can have a meshed surface, or it can comprise hollow or colored portions. In some embodiments, a positioning device can be an elongate rod or other structure configured to designated a specific length or offset from the onboard camera lens in the direction of an object to be photographed.

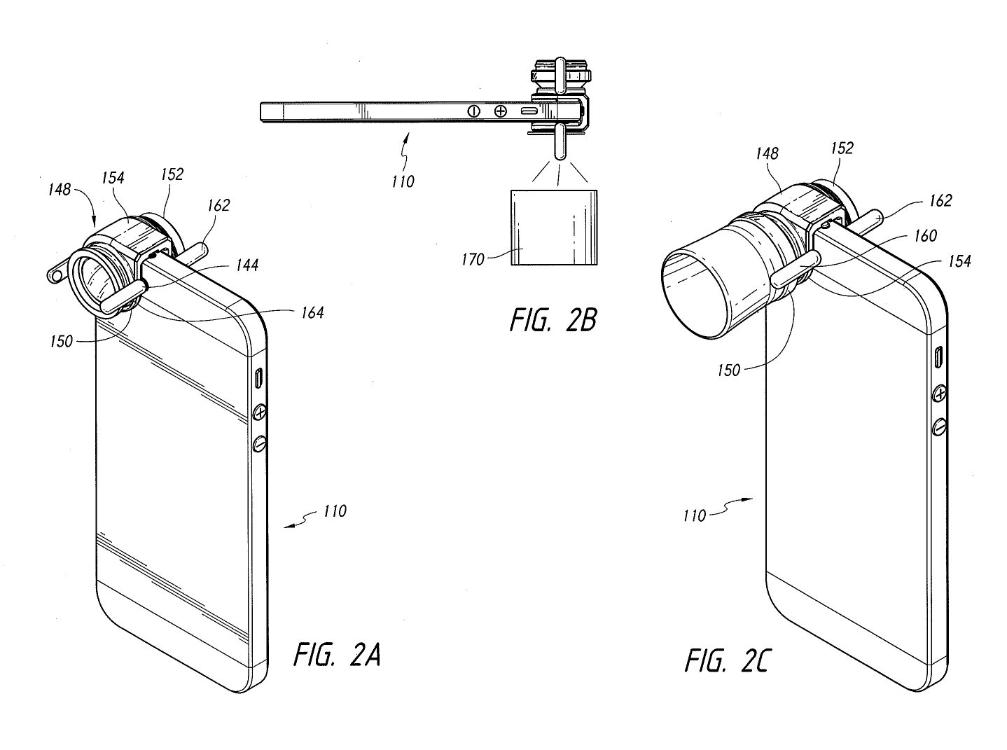

Referring now to FIGS. 2A-2C, 3A-3B, and 4A-4B, embodiments of light sources that project light onto a subject are shown. One advantage, among others, of some embodiments of the light source is that it may provide light to a subject 170, in addition to or in the absence of ambient light. A light source can be a light pipe 164 as seen in FIGS. 2A-2C. In some embodiments, multiple (e.g., two or more) light pipes may be included, such as a first lens light pipe 164 and a second lens light pipe 162 for a modular lensing system 148 that includes multiple lenses or other optical elements. The light pipe 162 can be connected to the modular lensing system 148. The modular lensing system 148 can include a retainer portion 154, a first lens 150, and a second lens 152. The modular lensing system 148 can cover a corner 144 of a mobile device 110. The corner 144 of the mobile device 110 can include an onboard camera 140 and a flash 142.

All or part of a light pipe can be made of an opaque covering jacket material to prevent light from being diffused before it reaches the subject 170. As shown in FIG. 2A, the first lens light pipe 164 can be placed near the first lens 150 of the modular lensing system 148. The second lens light pipe 162 can be placed near the second lens 152 of the modular lensing system 148. A light pipe 164 attached to a modular lensing system 148 can be positioned over a flash 144 of a mobile device 110 to substantially cover the flash 144. The light pipe 164 and the flash 144 can be in direct contact, or positioned from each other at a distance with a generally unobstructed light path between the light pipe 164 and the flash 144, such that the light pipe 164 can convey light from the flash 144 to the field of view of an onboard camera lens or an auxiliary lens.

In some embodiments, the light pipe 164 can be generally tubular (e.g., with a hollow space inside the pipe). In some embodiments, as shown in FIG. 2B, the light from the flash 144 can pass through the light pipe 164 to the subject 170. The light pipe 164 can be configured to direct light towards the subject 170.

In some embodiments, the light pipe 164 can be partially made of translucent or semi-transparent material. The light pipe 164 may be made of a material that can be bent. The light pipe 164 can alternatively be in other geometrical shapes, such as a cone, pyramid, or the like. In some embodiments, the light pipe 164 can include a color filter.

FIGS. 2B-2C illustrate a light pipe 160 used with a lens hood. The light pipe 160 can be used with a lens hood 156 attached to a modular lensing system 148. In addition to ambient lighting, a user may supplement lighting by using the light pipe 160 while using the lens hood 156. For example, the light pipe 160 can project light through a translucent or semi-transparent lens hood 156 to the subject 170.

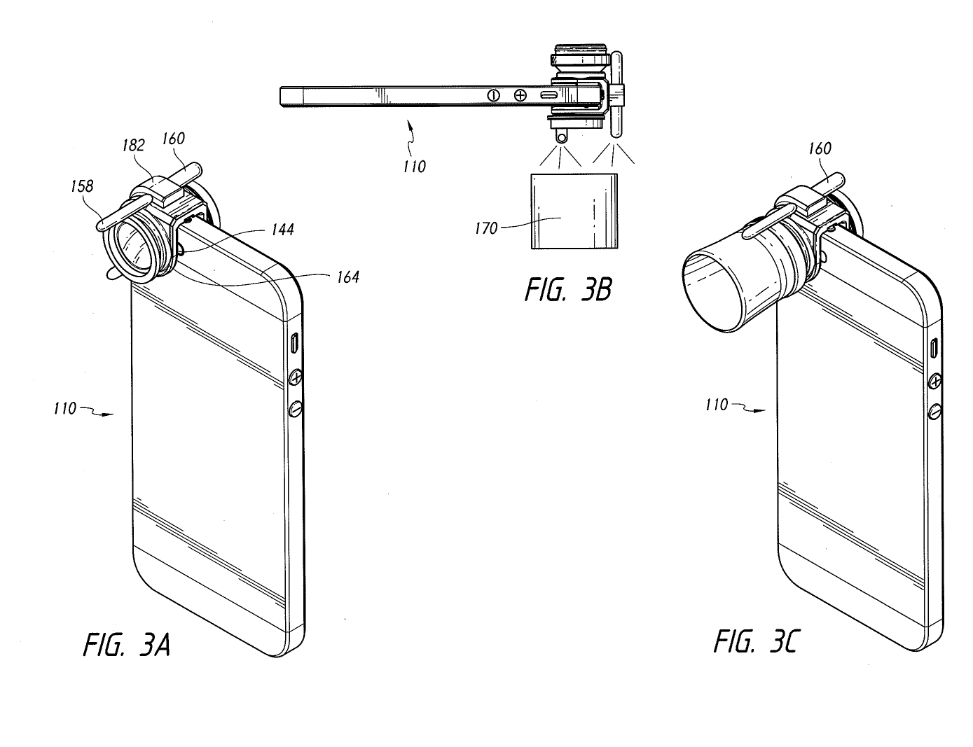

FIGS. 3A-3C illustrate an illuminating component with a power source. As illustrated in in FIG. 3A, an illuminating component 158 can be connected to a power source 182. The illuminating component 158 may include a bulb, LED, or some other structure capable of generating light. One advantage, among others, of some embodiments of powered illuminating component 158 is that it may generate light on its own rather than merely conveying light from another source, and therefore the powered illuminating component 158 may be placed in other parts of the modular lensing system 148 away from a flash 144. In some embodiments, the power source 182 is a battery. The power source 182 can be used to operate the illuminating component 158 independently from the operation of the flash 144 of the mobile device 110. In this embodiment, the illuminating component 158 may have a light frequency, intensity, color, etc. different from those of the flash 144 of the mobile device 110.

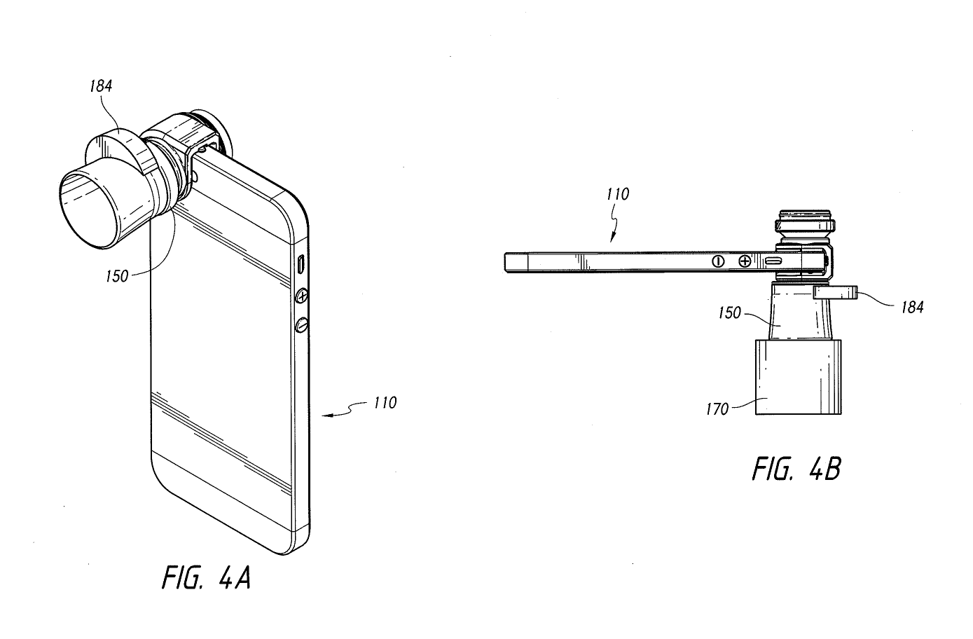

FIGS. 4A-4B illustrate a lens hood having a battery powered light source. As illustrated in FIGS. 4A-4B, the lens hood 156 can include a light source 184 configured to light the inside of the lens hood 156. One advantage, among others, of some embodiments of the light source 184 inside the lens hood 156 is that it can be used to light the inside of the hood 156 without light being diffused by the hood 156. The light source may include a bulb, LED, or some other component capable of generating light. In some embodiments, the light source 184 can be powered by a battery. In some embodiments, a user may configure the light source 184 to generate light with a desired light intensity, color, etc. to illuminate the subject 170. The lens hood 156 may be made of material that is translucent, semi-transparent, or opaque. As such, a user may use the light source 184 to deliver light to the inside of the lens hood 156, for instance to supplement ambient lighting, or in other instances, to light the inside of the lens hood 156 when the inside of the hood is dark.

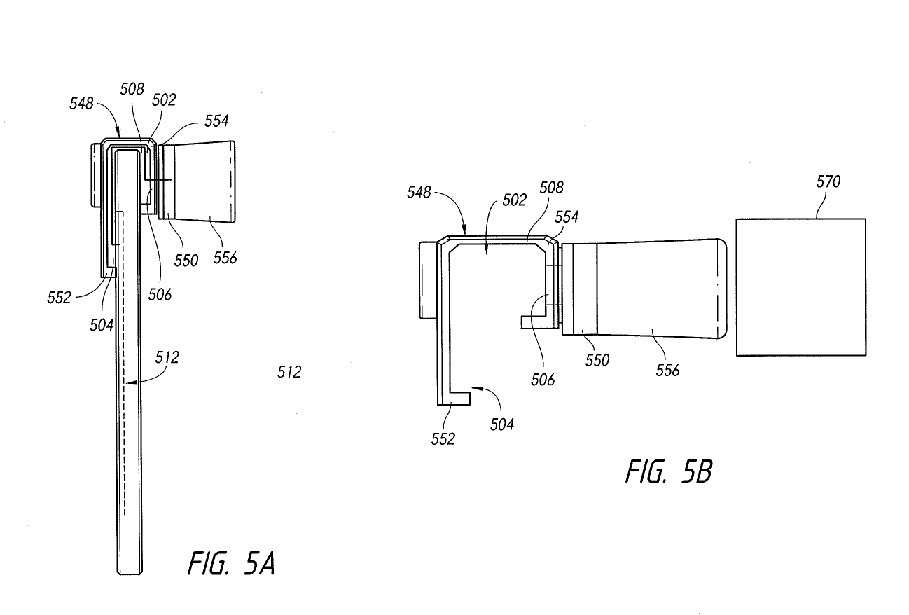

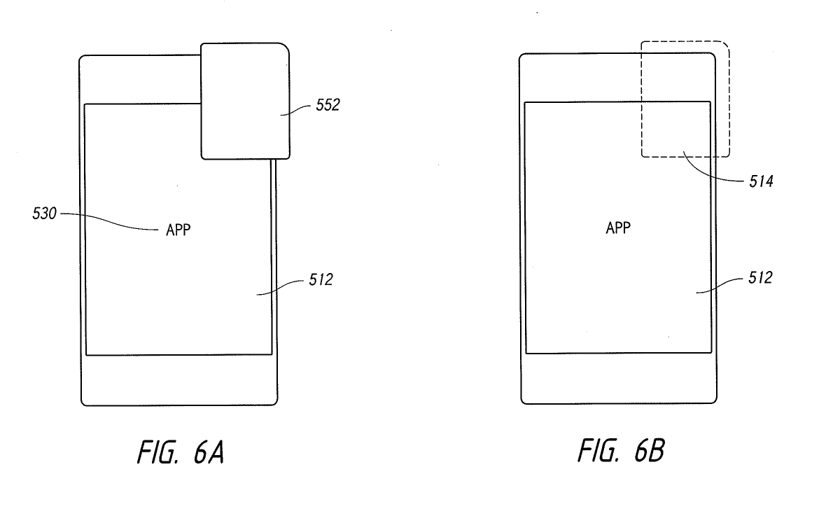

FIGS. 5A-5B and 6A-6B illustrate an embodiment of a lens hood and a periscopic light chamber that transfers light from mobile device display projected by the mobile device display to the lens hood. One advantage, among others, of some embodiments of the periscopic light chamber 502 is that it can be used to allow a mobile device application 530 to set a desired light setting to be applied to the subject 570. In some embodiments, as illustrated in FIG. 5A-5B, a periscopic light chamber 502 or light pathway may be couple to or integrated with a modular lensing system 548. The modular lensing system 548 can include a retainer portion 554, a display light-receiving portion 552, and an auxiliary lens 550. The retainer portion 554 of the modular lensing system 548 can generally cover a corner 544 (or some other portion, such as a portion of a top edge) of a mobile device 510. The corner 544 of the mobile device 510 can include an onboard camera 540 and a flash 542. As seen in FIGS. 6A-6B, the display-covering portion 552 of the modular lensing system 548 can cover a light emitting portion 514 of the mobile device display 512. In some embodiments, the mobile device display 512 in its entirety, or only a portion generally corresponding to the portion 514, can be adjusted by a mobile device application 530. For example, light intensity, color, and other characteristics may be adjusted.

As shown in FIG. 5A, the modular lens component 548 with a periscopic chamber 502 may have a light-capturing portion 504, a light-projecting portion 506, and a connecting portion 508. In some embodiments, a lens hood 556 may be connected to the modular lens component 548 with the periscopic light chamber 502. As shown in FIGS. 5A-5B, the light projecting portion 506 may be connected to or otherwise configured to convey light to or through the lens hood 556.

The periscopic light chamber 502 can be laminated by reflective coating. The light-capturing portion 504 of the periscopic chamber 502 can be generally inside of the display covering portion 552 of the modular lensing system 548. The light-projecting portion 506 of the periscopic chamber 502 can be generally near the auxiliary lens 550. The connecting portion 508 of the periscopic chamber 502 can be generally inside the retainer portion 554 of the modular lensing system 548. In some embodiments, as illustrated in FIGS. 5A and 6B, the light-capturing portion 504 can cover a light emitting portion 514 of display screen 512 of the mobile device 510 to capture a desired light characteristic (e.g. color, intensity, etc.) from the mobile device display 512. The light characteristic may be set using a mobile device application 530. The light captured by the light capturing portion 504 can be conveyed (e.g., reflected) by the connecting portion 508 and to the light projecting portion 506. The light may then be projected onto or otherwise conveyed to the subject 570.

In some embodiments, a user may place the lens hood 556 over the subject 570 for imaging purposes. A user may then select a desired light setting, such as an amber or blue hue, from the mobile device application 530. The desired light generated by the light emitting portion 514 of the mobile device display 512 can be conveyed by the light projecting portion 506 to the lens hood 556 and onto the subject 570. The user may then take image with the desired light setting that the user has set with the mobile device application 530, at a desired distance between the mobile device 510 and the subject 570 set by the longitudinal distance of the lens hood 556. In some embodiments, the mobile device application 530 may be used to process and analyze the image generated at a desired setting, for various purposes such as medical imaging and diagnosis. In some embodiments, the mobile device application 530 may transfer the image data to a database to process and analyze the image.

As illustrated in FIGS. 6A-6B, the mobile device application 530 may be used to project a desired visual effect onto a light emitting portion 514 of the mobile device display 512. The mobile device application 530 may include various visual effect settings, such as various hues, strobe light, incandescent light, etc. The mobile device application 530 may be used to control other components of the mobile device 510, such as the flash 544. In some embodiments, the mobile device application 530 can be used to process and analyze images or other information captured through the mobile device camera lens 540. A user may select a desired visual effect setting for various different purposes, such as medical imaging. Other uses of the disclosure described herein may include light therapy, laser pointer, torch light, light projector, LED light display, and etc.

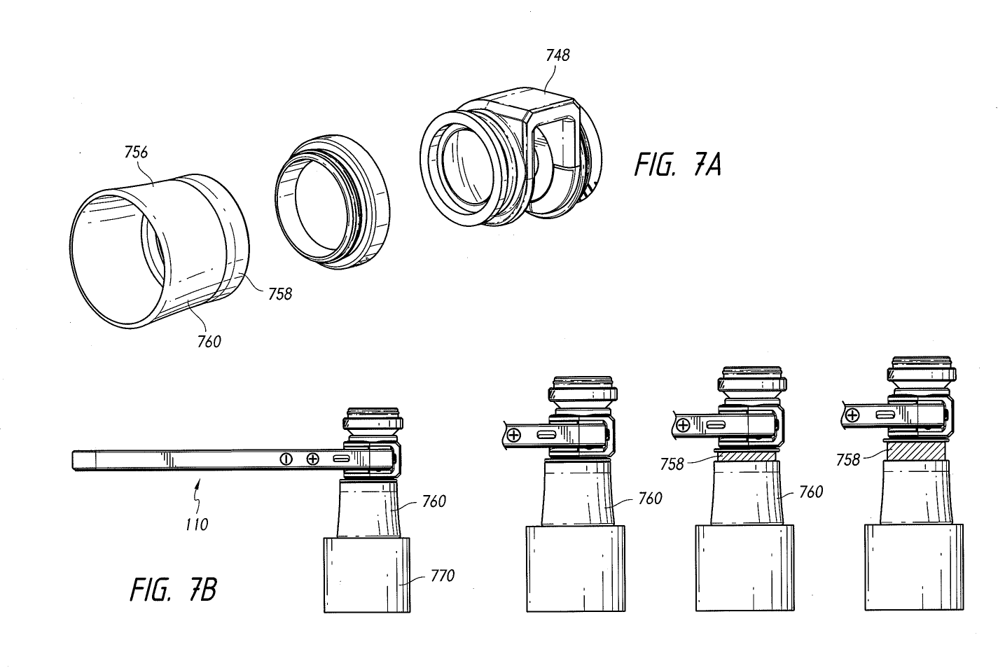

FIGS. 7A-7B illustrate an embodiment of a lens hood with a telescopically adjustable focus distance. One advantage, among others, of some embodiments of the lens hood 756 is that it can be used to adjust the distance between the mobile device 710 and the subject 770, while the hood 756 allows maintaining stable focal distance from the subject 770. In some embodiments, a lens hood 756 can include a distance adjustment portion 758 and a distal portion 760. As illustrated in FIG. 7B, the lens hood 756 can be connected to a modular lensing system 748.

In some embodiments, the distance adjustment portion 758 and the distal portion 760 can have grooves or threads. In this embodiment, the distance adjustment portion 758 and the distal portion 760 may be moved with respect to each other, in order to increase or decrease the distance between the mobile device 710 and the subject 770. For example, as seen in FIG. 7B, a user may pull, rotate, or push a distal portion 760 relative to a distance adjustment 758 portion of the hood in order to adjust the distance between the mobile device and the subject. The distal portion 760 can stay and hold its position once set. The lens hood 756 can be adjusted in increments within a given range to achieve a desirable focus distance. The distance adjustment portion 758 and the distal portion 760 can alternatively be connected using other distance adjustment mechanisms, such as a spring.

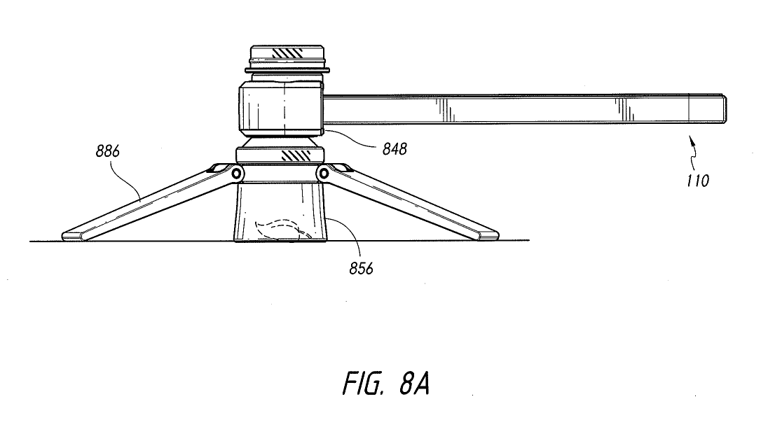

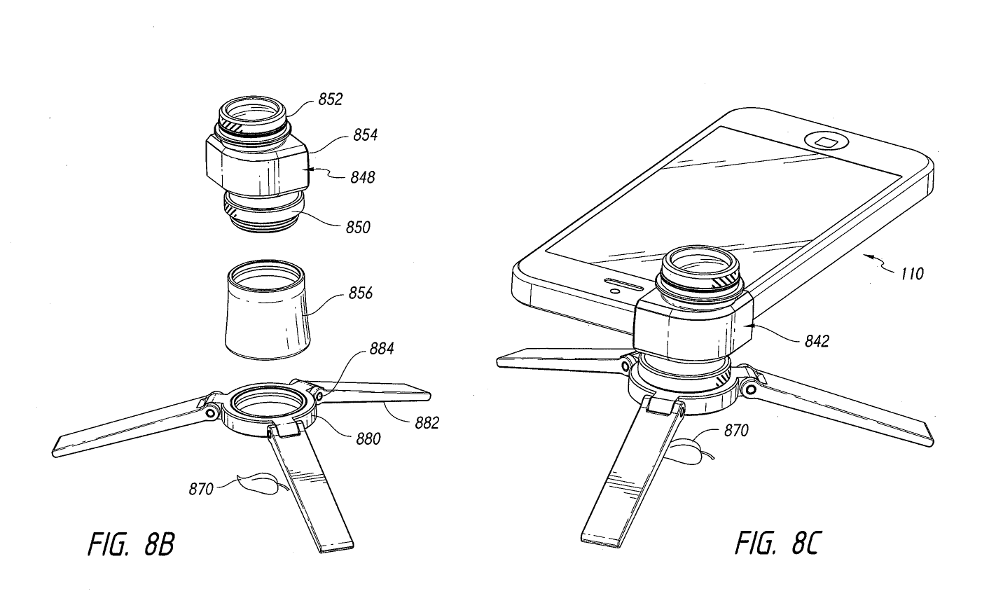

FIGS. 8A-8C illustrate an embodiment of a lens stand. One advantage, among others, of some embodiments of the lens stand 886 is that it can be used to stabilize the mobile electronic device 110 while it is placed vertically above the subject 870 to record images of the subject 870. In some embodiments, the lens stand 886 can include multiple (e.g., two or more) leg components 882, a connecting ring 880, and rotating hinge components 884 (e.g., for each leg component 882) on the connecting ring 880. As illustrated in FIGS. 8A-B, the lens stand 886 can be used with a lens hood 856 and/or a modular lensing system 848 having a first lens 850, a second lens 852, and a retainer portion 854.

In some embodiments, the modular lensing system has a retainer portion 854 shaped and sized to fit over the corner area of the mobile electronic device 110, such that the lens stand 886 is positioned generally in front of the onboard camera lens of the mobile electronic device. As illustrated in FIG. 8B, leg components 882 can be attached to the connecting ring 880 through hinge components 884. The connecting ring 880 may attach to the lens hood 856, or to the first lens 850, or to the retainer portion 854 of the modular lensing system 848.

In some embodiments, a user may use the lens stand 886 to resist shaking of the mobile electronic device 110 while taking close-up image, or to position the mobile electronic device 110 vertically above the subject 870 and allow the mobile electronic device 110 to operate without touching the mobile electronic device 110. The lens stand 886 can be placed directly over the subject without the need of secondary support, such as a lens hood 856. A user may pivot, rotate, or otherwise move leg components 882 using the hinges 884 to adjust the vertical distance between the mobile electronic device 110 and the subject 870, or to compact the size of the lens stand 886 for storage. The lens stand 886 can be locked in a particular position, such that the mobile electronic device 110 can remain in a particular angle or distance with respect to the subject 870. In some embodiments, the lens stand 886 can be configured to attach directly to the modular lensing system 848, without other imaging accessories such as the lens hood 856, the first lens 850, or the second lens 852. The lens stand 886 may be used with the mobile device alone, or with imaging accessories described herein, such as lens hood, periscopic light chamber, and the like.

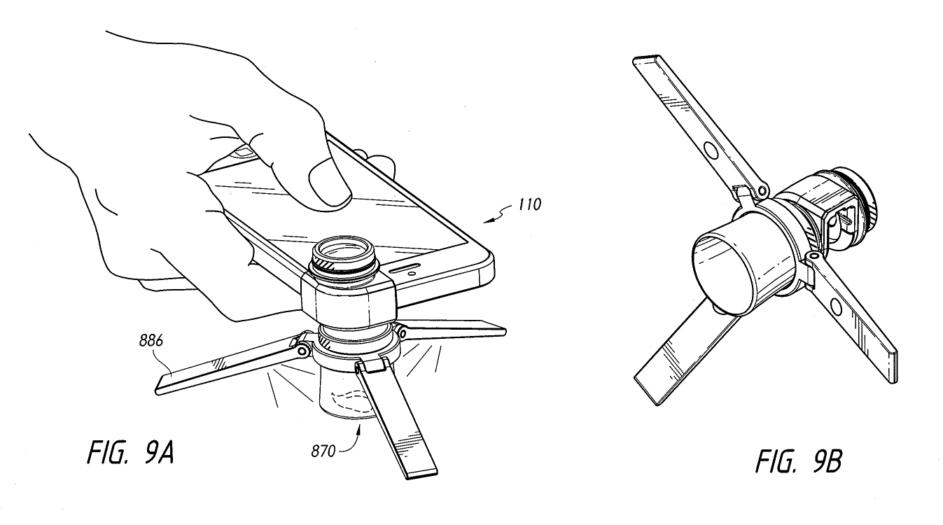

FIGS. 9A-9B illustrates the mobile device stand of FIG. 8, with the addition of a light source. One advantage, among others, of some embodiments of the light source 890 with the lens stand 886 is that it can be used to shine light onto the subject 870 from various angles to prevent, diminish, or resist the formation of shadows or dark areas on or around the subject. In some embodiments, a light source 890 may be attached to one or more leg components 882 of the lens stand 886. The light source 890 can be a bulb, LED, or some other structure configured to generate or convey light. As illustrated in FIG. 9A, a user may project light onto the subject 870 from all light sources 890 to prevent, diminish, or resist the formation of shadows and/or dark areas on or around the subject 870. Alternatively, a user may select to operate individual light sources 890 so as to create shadows and/or dark areas on around the subject 870 in desired angles and portions. The lens stand 886 with light source 860 may be used with imaging accessories having a light source, such as a lens hood with light source, periscopic light chamber, light pipe, and the like.

Although this invention has been disclosed in the context of a certain preferred embodiments and examples, it will be understood by those skilled in the art that the present invention extends beyond the specifically disclosed embodiments to other alternative embodiments and/or uses of the invention and obvious modifications and equivalents thereof It is also contemplated that various combinations or subcombinations of the specific features and aspects of the embodiments may be made and still fall within the scope of the invention. Accordingly, it should be understood that various features and aspects of the disclosed embodiments can be combine with or substituted for one another in order to form varying modes of the disclosed invention.

The following is claimed:

1. An imaging device configured to be attached to a mobile electronic device with an onboard camera with an onboard lens, the imaging device comprising:
a retainer configured to removably attach to a mobile electronic device;
an optical region attachable to the retainer, the optical region being configured to alter light passing through the optical region; and
a hood attachable to the imaging device, the hood being configured to extend from the optical region to a subject to be imaged.

2. The imaging device of claim 1, wherein the retainer is configured to attach to a corner of the mobile electronic device.

3. The imaging device of claim 1, wherein the hood is removably attachable to the imagine device.

4. The imaging device of claim 1, wherein the optical region is removably attachable to the retainer.

5. The imaging device of claim 4, further comprising one or more additional optical regions that are removably attachable to the retainer.

6. The imaging device of claim 5, wherein the optical regions each provide a different level of magnification.

7. The imaging device of claim 6, wherein at least one of the optical regions provides a magnification of at least 5×.

8. The imaging device of claim 7, wherein at least one of the optical regions provides a magnification of at least 10×.

9. The imaging device of claim 1, wherein the hood is generally translucent.

10. The imaging device of claim 9, wherein the hood is generally frusto-conical.

11. The imaging device of claim 9, wherein the hood is generally cylindrical.

12. The imaging device of claim 1, wherein the hood entirely surrounds a region to be photographed.

13. An imaging system comprising the imaging device of claim 1 in combination with the mobile electronic device.

14. An imaging device configured to be attached to a mobile electronic device with an onboard camera with an onboard lens, the imaging device comprising:
a retainer configured to removably attach to a mobile electronic device;
an optical region configured to alter light passing through the optical region; and
a camera stand configured to extend from the imaging device to a subject to be imaged.

15. The imaging device of claim 14, further comprising a retainer configured to removably attach the imaging device to mobile electronic device.

16. The imaging device of claim 15, wherein the retainer is configured to attach to a corner region of a mobile electronic device.

17. The imaging device of claim 16, wherein the retainer does not extend the full width across an edge of the mobile electronic device when attached to the mobile electronic device.

18. The imaging device of claim 17, wherein the retainer does not contact generally parallel sides of the mobile electronic device when attached to the mobile electronic device.

19. The imaging device of claim 18, wherein the retainer does not comprise dynamic mounts.

20. An imaging system comprising the imaging device of claim 19 in combination with the mobile electronic device.
